(19) United States
(12) Patent Application Publication
(10) Pub. No.: US 2025/0232405 A1
(43) Pub. Date: Jul. 17, 2025

(54) ELECTRONIC DEVICE AND CONTROL METHOD THEREFOR

(71) Applicant: SAMSUNG ELECTRONICS CO., LTD., Suwon-si (KR)

(72) Inventors: Seungho PARK, Suwon-si (KR); Youngsu MOON, Suwon-si (KR)

(21) Appl. No.: 19/169,581

(22) Filed: Apr. 3, 2025

Related U.S. Application Data
(63) Continuation of application No. PCT/IB2023/060785, filed on Oct. 26, 2023.

(30) Foreign Application Priority Data
Nov. 24, 2022 (KR) 10-2022-0159109
Jan. 16, 2023 (KR) 10-2023-0005910

(51) Int. Cl. G06T 3/4053; G06T 3/4046

(52) U.S. Cl. CPC G06T 3/4053; G06T 3/4046

(57) ABSTRACT

Disclosed is an electronic device. The electronic device comprises a display; a memory; and at least one processor comprising processing circuitry. At least one processor, individually and/or collectively, may be configured to control the display to: acquire a high-resolution image having a threshold resolution or higher from a low-resolution image below the threshold resolution using a first artificial intelligence model, and control the display to output the acquired high-resolution image. The first artificial intelligence model is configured to learn objective data defined as a weighted sum of a plurality of loss values of different types and changed continuously. A second artificial: intelligence model is configured to identify weight conditions corresponding to the plurality of loss values based on the low-resolution image and provide the identified weight conditions to the first artificial intelligence model.

### CROSS-REFERENCE TO RELATED APPLICATIONS

This application is a continuation of International Application No. PCT/IB2023/060785 designating the United States, filed on Oct. 26, 2023, in the Korean Intellectual Property Receiving Office and claiming priority to Korean Patent Application Nos. 10-2022-0159109, filed on Nov. 24, 2022, and 10-2023-0005910, filed on Jan. 16, 2023, in the Korean Intellectual Property Office, the disclosures of each of which are incorporated by reference herein in their entireties.

### BACKGROUND

### Field

The disclosure relates to an electronic device and a control method therefor, and for example, to an electronic device that performs super-resolution processing, and a control method therefor.

### Description of Related Art

Various types of electronic devices have been developed and supplied in accordance with the development of electronic technology. In particular, display devices used in various places such as homes, offices, and public places, have been continuously developed over recent years.

Recently, a demand for high-resolution image services has increased significantly. Due to this demand, deep learning-based technologies such as super resolution and style transfer are being used in image processing.

The super resolution may refer to a technology for restoring low-resolution input images into high-resolution images through a series of media processing. For example, a convolutional neural network (CNN) model including multiple/a plurality of layers based on deep learning may be used to restore the low-resolution input image to the high-resolution image by scaling the same horizontally and vertically.

### SUMMARY

According to an example embodiment of the present disclosure, provided is an electronic device including: a display; a memory storing information on a first artificial intelligence model and a second artificial intelligence model; and at least one processor, comprising processing circuitry, connected to the display and the memory and individually and/or collectively configured to control the electronic device to: acquire a high-resolution image having a threshold resolution or higher from a low-resolution image below the threshold resolution using the first artificial intelligence model, and control the display to output the acquired high-resolution image, wherein the first artificial intelligence model is configured to learn objective data defined as a weighted sum of a plurality of loss values of different types and changed continuously, and the second artificial intelligence model is configured to identify weight conditions corresponding to the plurality of loss values based on the low-resolution image and provide the identified weight conditions to the first artificial intelligence model.

The second artificial intelligence model may be configured to be trained based on first information including the output weight condition and target weight condition of the second artificial intelligence model, and second information including the output image and objective data of the first artificial intelligence model.

The first information may include a difference value between the output weight condition and target weight condition of each of the plurality of loss values of different types corresponding to region data of a training sample, and the second information may include a plurality of loss values of different types between the region data of the training sample and the objective data that is changed continuously.

The second information may include a pixel-wise objective map loss, a reconstruction loss, and a perceptual loss, representing a difference between the output image of the first artificial intelligence model and a target high-resolution image.

The second artificial intelligence model may be configured to predict a weight condition map of a size corresponding to the low-resolution image and provide the predicted map to the first artificial intelligence model, and the first artificial intelligence model may be include a super resolution (SR) branch including a plurality of spatial feature transform (SFT) layers and a condition branch providing conditions corresponding to the plurality of SFT layers based on the weight condition map.

The first artificial intelligence model may be configured to acquire the high-resolution image based on an optimal objective data combination for each of a plurality of regions included in the low-resolution image, and learn the plurality of objective data acquired based on an arbitrary weight condition map acquired based on a condition that is changed arbitrarily.

At least one processor, individually and/or collectively, may be configured to: acquire the weight condition map for the plurality of loss values respectively corresponding to the plurality of regions included in the low-resolution image using the second artificial intelligence model, and acquire the high-resolution image based on the weighted sum of the plurality of loss values corresponding to the acquired weight condition map using the first artificial intelligence model.

At least one processor, individually and/or collectively, may be configured to: acquire a target weight condition map by selecting t having a lowest learned perceptual image patch similarity (LPIPS) for each pixel while changing the condition t from a first value to a second value stepwise using the second artificial intelligence model, and train the second artificial intelligence model based on a difference value between the arbitrary weight condition map and the target weight condition map.

The plurality of loss values of different types may include a loss value based on at least one of a reconstruction loss, an adversarial loss, a perceptual loss, or a distortion loss.

According to an example embodiment of the present disclosure, a method for controlling an electronic device is provided, the method including: acquiring a high-resolution image having a threshold resolution or higher from a low-resolution image below the threshold resolution using a first artificial intelligence model; and outputting the acquired high-resolution image, wherein the first artificial intelligence model is configured to learn objective data defined as a weighted sum of a plurality of loss values of different types and changed continuously, and the second artificial intelligence model is configured to identify weight conditions corresponding to the plurality of loss values based on the low-resolution image and provide the identified weight conditions to the first artificial intelligence model.

According to an example embodiment of the present disclosure, provided is a non-transitory computer-readable medium storing a computer instruction which, when executed by at least one processor, comprising processing circuitry, of an electronic device causes the electronic device to perform operations comprising: acquiring a high-resolution image having a threshold resolution or higher from a low-resolution image below the threshold resolution using a first artificial intelligence model, and outputting the acquired high-resolution image, the first artificial intelligence model is configured to learn objective data defined as a weighted sum of a plurality of loss values of different types and changed continuously, and the second artificial intelligence model is configured to identify weight conditions corresponding to the plurality of loss values based on the low-resolution image and provide the identified weight conditions to the first artificial intelligence model.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an implementation example of an electronic device according to various embodiments;

FIG. 2A is a block diagram illustrating an example configuration of the electronic device according to various embodiments;

FIG. 2B is a block diagram illustrating an example configuration of a display device according to various embodiments;

FIG. 3 is a diagram illustrating an overview of an example single-image super-resolution (SISR) framework according to various embodiments;

FIGS. 4A, 4B and 4C are diagrams illustrating an implementation example of a first artificial intelligence model according to various embodiments;

FIGS. 5A, 5B and 5C are diagrams illustrating an implementation example of the first artificial intelligence model and a second artificial intelligence model according to various embodiments;

FIGS. 6A and 6B are diagrams illustrating an example objective set identification method according to various embodiments;

FIG. 7 is a diagram illustrating an example optimal objective selection method according to various embodiments;

FIGS. 8A, 8B, 8C, 8D, 9, 10A, 10B, and 11 are diagrams illustrating an example objective trajectory according to various embodiments; and

FIG. 12 is a diagram illustrating an example effect according to various embodiments.

### DETAILED DESCRIPTION

Terms used in the disclosure are briefly described, and the present disclosure is then described in greater detail with reference to the drawings.

General terms currently widely used are selected as terms used in the present disclosure in consideration of their functions in the present disclosure, and may be changed based on the intentions of those skilled in the art or a judicial precedent, the emergence of a new technique, or the like. In addition, terms may be arbitrarily selected. In this case, the meanings of such terms are mentioned in detail in corresponding descriptions of the present disclosure. Therefore, the terms used in the present disclosure should be defined on the basis of the meanings of the terms and the contents throughout the present disclosure rather than simple names of the terms.

In the disclosure, an expression “have”, “may have”, “include”, “may include”, or the like, indicates the presence of a corresponding feature (for example, a numerical value, a function, an operation, or a component such as a part), and does not exclude the presence of an additional feature.

In the present disclosure, an expression “A or B”, “at least one of A and/or B”, “one or more of A and/or B”, or the like, may include all possible combinations of items enumerated together. For example, “A or B”, “at least one of A and B”, or “at least one of A or B” may indicates all of 1) a case where at least one A is included, 2) a case where at least one B is included, or 3) a case where both of at least one A and at least one B are included.

Expressions “first”, “second”, and the like, used in the disclosure may qualify various components regardless of the sequence or importance of the components. The expression is used simply to distinguish one component from another component, and does not limit the corresponding component.

If any component (for example, a first component) is mentioned to be “(operatively or communicatively) coupled with/to” or “connected to” another component (for example, a second component), it should be understood that any component may be directly coupled to another component or may be coupled to another component through yet another component (for example, a third component).

An expression “configured (or set) to” used in the present disclosure may be replaced with an expression “suitable for”, “having the capacity to”, “designed to”, “adapted to”, “made to”, or “capable of” based on a context. The expression “configured (or set) to” may not necessarily indicate “specifically designed to” in hardware.

In some contexts, an expression “a device configured to” may indicate that the device may “perform˜” together with another device or component. For example, “a processor configured (or set) to perform A, B and C” may indicate a dedicated processor (for example, an embedded processor) that performs a corresponding operation or a generic-purpose processor (for example, a central processing unit (CPU) or an application processor) that performs the corresponding operation by executing at least one software program stored in a memory device.

It should be understood that a term “include”, “formed of”, or the like used in this application specifies the presence of features, numerals, steps, operations, components, parts, or combinations thereof, mentioned in the disclosure, and does not preclude the presence or addition of one or more other features, numerals, steps, operations, components, parts, or combinations thereof.

In the disclosure, a “module” or a “˜er/or” may perform at least one function or operation, and be implemented by hardware, software, or a combination of hardware and software. In addition, a plurality of “modules” or a plurality of “˜ers/˜ors” may be integrated in at least one module to be implemented by at least one processor (not shown) except for a “module” or a “˜er/or” that needs to be implemented by specific hardware.

Various elements and regions in the drawings are schematically shown. Therefore, the spirit of the present disclosure is not limited to relative sizes or intervals shown in the accompanying drawings.

Hereinafter, various example embodiments of the present disclosure are described in greater detail with reference to the accompanying drawings.

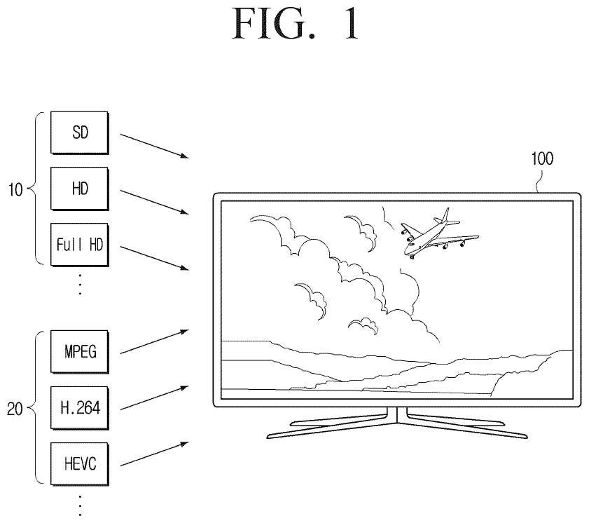

FIG. 1 is a diagram illustrating an implementation example of an electronic device according to various embodiments.

An electronic device 100 may be implemented as a television (TV) or a set-top box as shown in FIG. 1, and is not limited thereto. The electronic device 100 may be applied without limitation as long as the device has an image processing and/or a display function, such as a smartphone, a tablet personal computer (PC), a laptop PC, a head mounted display (HMD), a near eye display (NED), a large format display (LFD), a digital signage, a digital information display (DID), a video wall, a projector display, a camera, a camcorder, a printer, etc.

The electronic device 100 may receive various compressed images or various-resolution images. For example, the electronic device 100 may receive the image in a compressed form such as moving picture experts group (MPEG) (for example, MP2, MP4, or MP7), joint photographic coding experts group (JPEG), advanced video coding (AVC), H.264, H.265, or high efficiency video codec (HEVC) 20. The electronic device 100 may receive any one of a standard definition (SD) image, a high definition (HD) image, a full HD image, an ultra HD image 10.

According to an embodiment, even if the electronic device 100 is implemented as a TV capable of displaying an image having a resolution of UHD or higher, there are many cases where the images such as the standard definition (SD) image, the high definition (HD) image, and the full HD image (hereinafter referred to as a low-resolution image) are input because there is a shortage of content having the resolution of UHD or higher. In this case, the electronic device 100 may transform the input low-resolution image into an image of/having the resolution of UHD or higher (hereinafter referred to as a high-resolution image) through super resolution (SR) processing and provide the same. The SR processing indicates processing that converts the low-resolution image having a low resolution into the high-resolution image through a series of media processing.

For example, the SR processing may be broadly classified into single image super resolution (hereinafter, SISR) and multi image super resolution (hereinafter, MISR) depending on whether one image or a plurality of images are used.

The super resolution, for example, the SISR, may require restoring the low-resolution image to the high resolution image, and there may be a plurality of correct answers for a high-resolution target image to be restored. To be accurate, this case indicates an undefinable problem for which there is no unique correct answer, and may be referred to as a regular inverse problem or Ill-posed problem.

To address this difficulty, the high-resolution target image may be defined as ground truth (GT), and then transformed into the low-resolution image through blurring, down sampling, noise injection, or the like to transform this high-resolution target image into the low-resolution image. A model may be trained to restore the low-resolution image to the GT using a certain method.

A pixel-wise distortion-oriented loss L1 or L2 may be widely used in early studies and assist in acquiring a peak signal-to-noise ratio (PSNR). However, such a loss may cause the model to generate an average of a possible high-resolution (HR) solution, which usually results in a blurry and visually unsatisfactory image.

To address this problem, a perceptual-oriented loss, such as perceptual loss or generative adversarial loss, is introduced to generate a realistic image having fine details. However, although this perceptual loss is used in various SR methods, this loss may also lead to undesirable side effects such as unnatural details and structural distortion.

Accordingly, the description below describes various embodiments in which the model performs the SR processing through an optimal loss combination by learning a weight condition corresponding to the loss and using a loss specifically designed to mitigate the side effects and improve the perceptual accuracy of image reconstruction.

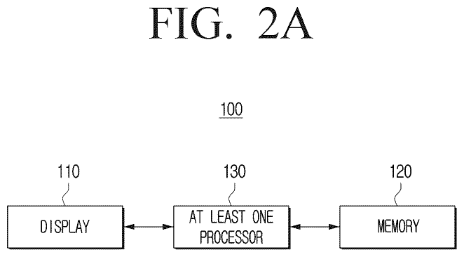

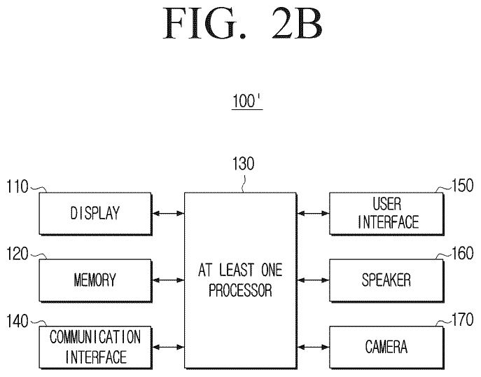

FIG. 2A is a block diagram illustrating an example configuration of the electronic device according to various embodiments.

Referring to FIG. 2A, the electronic device 100 may include a display 110, a memory 120, and at least one processor (e.g., including processing circuitry) 130.

The display 110 may be implemented as a display including a self-light emitting element or a display including a non self-light emitting element and a backlight. For example, the display 110 may be implemented in any of various types of displays such as a liquid crystal display (LCD), an organic light emitting diode (OLED) display, a light emitting diode (LED) display, a micro light emitting diode (micro LED) display, a mini LED display, a plasma display panel (PDP), a quantum dot (QD) display, or a quantum dot light-emitting diode (QLED) display. The display 110 may also include a driving circuit, a backlight unit, and the like, which may be implemented in a form such as an a-si thin film transistor (TFT), a low temperature poly silicon (LTPS) TFT, or an organic TFT (OTFT). For example, the display 110 may be implemented as a flat display, a curved display, a foldable and/or rollable flexible display, or the like.

The memory 120 may store data necessary for the various embodiments. The memory 120 may be implemented in the form of a memory embedded in an electronic device 100 or in the form of a memory detachable from the electronic device 100, based on a data storage purpose. For example, data for driving the electronic device 100 may be stored in the memory embedded in the electronic device 100′, and data for an extension function of the electronic device 100 may be stored in the memory detachable from the electronic device 100. The memory embedded in the electronic device 100 may be implemented as at least one of a volatile memory (for example, a dynamic random access memory (DRAM), a static RAM (SRAM), or a synchronous dynamic RAM (SDRAM)), or a non-volatile memory (for example, an one time programmable read only memory (OTPROM), a programmable ROM (PROM), an erasable and programmable ROM (EPROM), an electrically erasable and programmable ROM (EEPROM), a mask ROM, a flash ROM, a flash memory (for example, a NAND flash or a NOR flash), a hard drive, or a solid state drive (SSD)). In addition, the memory detachable from the electronic device 100 may be implemented in the form of a memory card (for example, a compact flash (CF), a secure digital (SD), a micro secure digital (Micro-SD), a mini secure digital (Mini-SD), an extreme digital (xD), or a multi-media card (MMC)), or an external memory capable of being connected to a universal serial bus (USB) port (for example, a USB memory).

At least one processor 130 may include various processing circuitry and control overall operations of the electronic device 100. For example, at least one processor 130 may be connected to each component of the electronic device 100 to thus control the overall operations of the electronic device 100. For example, at least one processor 130 may be electrically connected to the display 110 and the memory 120, and control the overall operations of the electronic device 100. At least one processor 130 may be one or more processors.

At least one processor 130 may perform the operation of the electronic device 100 according to the various embodiments by executing at least one instruction stored in the memory 120.

A function related to an artificial intelligence according to the present disclosure may be operated by the processor and memory of the electronic device 100.

At least one processor 130 may be one or more processors. One or more processors may include at least one of a central processing unit (CPU), a graphic processing unit (GPU), or a neural processing unit (NPU), and is not limited to the examples of the processors described above.

The CPU is a general-purpose processor which may perform not only general operations but also artificial intelligence operations, and may efficiently execute complex programs through a multi-layered cache structure. The CPU may be advantageous for a serial processing method that enables organic linkage between a previous calculation result and a next calculation result through sequential calculations. The general-purpose processor is not limited to the above example except for a case where the processor is specified as the above-mentioned CPU.

The GPU is a processor for large-scale operations such as floating-point operations used for graphics processing, and may perform the large-scale operations in parallel by integrating a large number of cores. In particular, the GPU may be advantageous for a parallel processing method such as a convolution operation or the like compared to the CPU. In addition, the GPU may be used as a co-processor to supplement a function of the CPU. The processor for the large-scale operations is not limited to the above example except for a case where the processor is specified as the above-mentioned GPU.

The NPU is a processor specialized in the artificial intelligence operation using an artificial neural network, and each layer included in the artificial neural network may be implemented in hardware (e.g., silicon). Here, the NPU is specially designed based on requirements of a company, and may thus have a lower degree of freedom than the CPU or the GPU. However, the NPU may efficiently process the artificial intelligence operation required by the company. As the processor specialized for the artificial intelligence operation, the NPU may be implemented in various forms such as a tensor processing unit (TPU), an intelligence processing unit (IPU), and a vision processing unit (VPU). The artificial intelligence processor is not limited to the above example except for a case where the processor is specified as the above-mentioned NPU.

In addition, at least one processor 130 may be implemented in a system on chip (SoC). Here, the SoC may further include the memory 120 and a network interface such as a bus for data communication between the processor 130 and the memory 120 in addition to at least one processor 130.

If the system on chip (SoC) included in the electronic device 100 includes a plurality of processors, the electronic device 100 may use some of the plurality of processors to perform the artificial intelligence operation (e.g., operation related to the learning or inference of an artificial intelligence model). For example, the electronic device may perform the artificial intelligence operation using at least one of the GPU, NPU, VPU, TPU, or a hardware accelerator that is specialized for the artificial intelligence operation such as a convolution operation or a matrix multiplication operation among the plurality of processors. However, this configuration is only an example, and the electronic device may process the artificial intelligence operation using the general-purpose processor such as the CPU. The processor 130 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without] limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

In addition, the electronic device 100 may perform an operation for an artificial intelligence function using multi-cores (e.g., dual-core or quad-core) included in at least one processor. For example, the electronic device may perform the artificial intelligence operation such as the convolution operation or the matrix multiplication operation in parallel using the multi-cores included in the processor.

At least one processor 130 may perform control to process input data based on a predefined operation rule stored in the memory 120 or the artificial intelligence model. The predefined operation rule or the artificial intelligence model may be generated by learning.

“Being generated through learning” indicates that the predefined operation rule or artificial intelligence model of a desired feature is generated by applying a learning algorithm to a large number of learning data. Such learning may be performed by a device itself in which the artificial intelligence is performed according to the present disclosure, or through a separate server/system.

The artificial intelligence model may include a plurality of neural network layers. At least one layer may have at least one weight value, and an operation of the layer may be performed through an operation result of a previous layer and at least one defined operation. Examples of the neural network may include a convolutional neural network (CNN), a recurrent neural network (RNN), a deep neural network (DNN), a restricted Boltzmann machine (RBM), a deep belief network (DBN), a bidirectional recurrent deep neural network (BRDNN), a deep Q-network, and a transformer. However, the neural network of the present disclosure is not limited to the above examples except for a case where a type of the neural network is specified.

The learning algorithm may refer to a method of training a predetermined target device (e.g., robot) using a large number of learning data for the predetermined target device to make a decision or a prediction for itself.

Examples of the learning algorithm may include a supervised learning algorithm, an unsupervised learning algorithm, a semi-supervised learning algorithm, or a reinforcement learning algorithm. However, the learning algorithm of the present disclosure is not limited to the above-described examples unless specified otherwise. Hereinafter, for convenience of description, at least one processor 130 is referred to as the processor 130.

FIG. 2B is a block diagram illustrating an example configuration of the display device according to various embodiments.

Referring to FIG. 2B, the electronic device 100 may include the display 110, the memory 120, at least one processor (e.g., including processing circuitry) 130, a communication interface (e.g., including communication circuitry) 140, a user interface (e.g., including interface circuitry) 150, a speaker 160, and a camera 170. The description may not repeat detailed descriptions of the components shown in FIG. 2B that overlap with the components shown in FIG. 2A.

The communication interface 140 may include various communication circuitry and may support various communication methods based on the implementation example of the electronic device 100′. For example, the communication interface 140 may communicate with an external device, an external storage medium (e.g., USB memory), an external server (e.g., cloud hard) or the like using a communication method such as a Bluetooth, an access point (AP) based wireless fidelity (Wi-Fi, e.g., wireless local area network (LAN)), a zigbee, a wired/wireless local area network (LAN), a wide area network (WAN), Ethernet, an IEEE 1394, a high definition multimedia interface (HDMI), a universal serial bus (USB), a mobile high-definition link (MHL), an audio engineering society/European broadcasting union (AES/EBU) communication, an optical communication, or a coaxial communication.

The user interface 150 may include various circuitry and may be implemented as a device such as a button, a touch pad, a mouse, or a keyboard, or may be implemented as a touch screen or the like which may also perform a manipulation input function in addition to the above-described display function. According to an embodiment, the user interface 150 may be implemented as a remote control transceiver to thus receive a remote control signal. The remote control transceiver may receive or transmit the remote control signal from/to an external remote control device through at least one of infrared communication, Bluetooth communication, or Wi-Fi communication.

The speaker 160 may output an audio signal. For example, the speaker 160 may convert and amplify a digital audio signal processed by the processor 130 into an analog audio signal, and output the same. For example, the speaker 160 may include at least one speaker unit, a digital to analog (D/A) converter, an audio amplifier, or the like, which may output at least one channel. For example, the speaker 160 may be implemented to output various multi-channel audio signals. In this case, the processor 130 may control the speaker 160 to enhance and output the input audio signal corresponding to enhancement processing of the input image.

The camera 170 may be turned on and capture the image based on a predetermined event. The camera 170 may convert the captured image into an electrical signal and generate image data based on the converted signal. For example, an object may be converted into an electrical image signal by a semiconductor optical device (charge coupled device (CCD)), and the converted image signal may be amplified and converted into a digital signal and then signal-processed.

In addition, the electronic device 100 may include a microphone (not shown), a sensor (not shown), a tuner (not shown), and a demodulator (not shown) according to an implementation example.

The microphone (not shown) is a component for receiving a user voice or other sounds to convert the same into the audio data. However, according to an embodiment, the electronic device 100 may receive the user voice, which is input through the external device, through the communication interface 140.

The sensor may include any of various types of sensors, such as a touch sensor, a proximity sensor, an acceleration sensor, a geomagnetic sensor, a gyro sensor, a pressure sensor, a position sensor, or a light sensor.

The tuner (not shown) may receive a radio frequency (RF) broadcast signal by tuning a channel selected by a user or all pre-stored channels among the RF broadcast signals received through an antenna.

The demodulator (not shown) may receive and demodulate a digital intermediate frequency (DIF) signal converted by the tuner, and also perform channel decoding or the like.

According to an embodiment, the processor 130 may acquire a high-resolution image having a threshold resolution or higher from a low-resolution image below the threshold resolution using a first artificial intelligence model. The first artificial intelligence model may be pre-stored in the memory 120, and is not necessarily limited thereto. At least some configurations related to the first artificial intelligence model may be stored in the external device (e.g., external server). The processor 130 may then control the display 110 to output the acquired high-resolution image. However, as another example, the electronic device 100 may not include the display, and in this case, the electronic device 100 may transmit the high-resolution image to the external device including a display.

For example, the first artificial intelligence model may be implemented to learn objective data defined as a weighted sum of a plurality of loss values of different types, and changed continuously. In this case, the first artificial intelligence model may acquire a high-resolution output image (hereinafter, high-resolution image) based on a weight condition corresponding to each of the plurality of loss values identified based on the low-resolution image (hereinafter, the low-resolution image). Here, the plurality of loss values of different types may include a loss value based on at least one of a reconstruction loss, an adversarial loss, a perceptual loss, or a distortion loss.

For example, the weight condition provided to the first artificial intelligence model may be provided from a second artificial intelligence model to the first artificial intelligence model. In this case, the second artificial intelligence model may be implemented to identify the weight condition corresponding to each of the plurality of loss values based on the low-resolution image and provide the identified weight condition to the first artificial intelligence model. For example, the second artificial intelligence model may be trained based on first information including the output weight condition and target weight condition of the second artificial intelligence model, and second information including the output image and objective data of the first artificial intelligence model. The first information may include a difference value between the output weight condition and target weight condition of each of the plurality of loss values of different types corresponding to region data of a training sample. In addition, the second information may include the plurality of loss values of different types between the region data of the training sample and the objective data that is changed continuously. Hereinafter, for the convenience of description, the low-resolution image is referred to as an LR image, and the high-resolution image is referred to as a HR image.

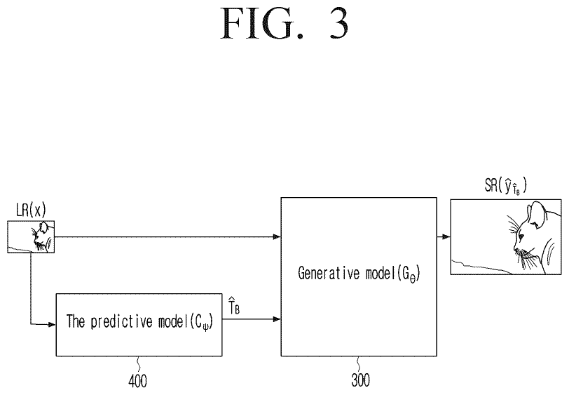

FIG. 3 is a diagram illustrating an example of a single-image super-resolution (SISR) framework according to various embodiments.

Referring to FIG. 3, the SISR Framework may include a first artificial intelligence model 300 and a second artificial intelligence model 400. For example, the first artificial intelligence model 300 may be implemented as a generative model Ge, and the second artificial intelligence model 400 may be implemented as a predictive model Cv. The second artificial intelligence model 400 may predict an optimal objective map (or weight condition map) Is of an LR size for an input LR image and provide the predicted map to the first artificial intelligence model 300. In this case, the first artificial intelligence model 300 may output a corresponding SR image that is as similar as possible to a HR counterparty based on the optimal objective map \hat{T}_{B}.

For example, the first artificial intelligence model 300 may acquire the optimal objective map according to Equation 1 below. In addition, the second artificial intelligence model 400 may acquire the SR image according to Equation 2 below.

$${\hat{y}}_{{\hat{T}}_{B}} = {G}_{θ} ( x \vert {\hat{T}}_{B} ) \qquad [ Equation 1 ]$$

$${\hat{T}}_{B} = {C}_{φ} ( x ) \qquad [ Equation 2 ]$$

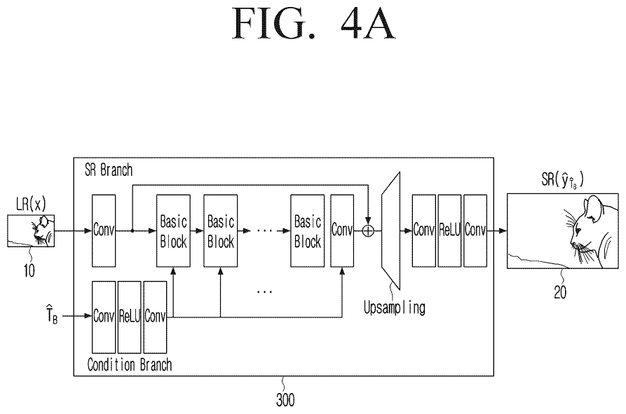

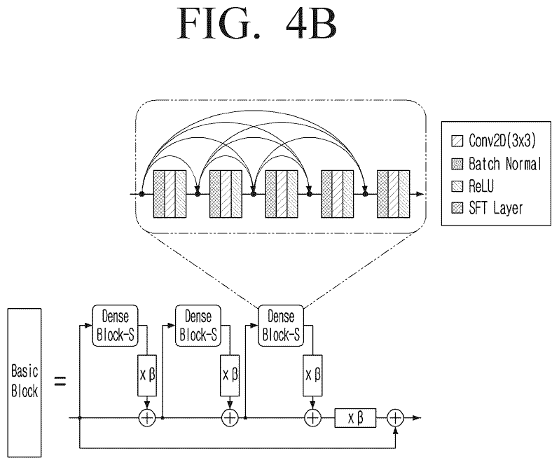

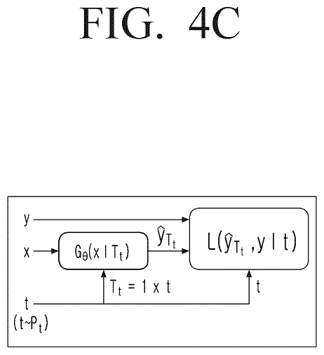

FIGS. 4A, 4B and 4C are diagrams illustrating an implementation example of the first artificial intelligence model according to various embodiments.

FIG. 4A shows an implementation example of the first artificial intelligence model 300, which may be implemented as a generative model Ge.

As shown in FIG. 4A, the first artificial intelligence model 300 may include the plurality of neural network layers, and each of the plurality of neural network layers may include a plurality of parameters. In this case, the first artificial intelligence model 300 may perform a neural network operation based on an operation result of a previous layer and an operation between the plurality of parameters.

For example, operation data that is output through an activation function, such as a rectified linear unit (ReLU) operation, after applying a convolution filter in an arbitrary layer may be output. In this case, the operation data output from the layer may be multi-channel data, and, for example, 64 feature map (or activation map) data may be output and provided to a next layer. However, for example, the feature map data may be stored in the memory (internal buffer or external memory) and then provided to the next layer. However, FIG. 4A omits the corresponding configuration. In this case, the first artificial intelligence model 300 may perform the operation using various types of activation functions such as identity function, logistic sigmoid function, hyperbolic tangent (tan h) function, ReLU function, and leaky ReLU function.

As an example, the first artificial intelligence model 300 may be implemented as a super resolution (SR) branch and a condition branch. For example, the SR branch may be implemented to perform the SR processing using a plurality of basic blocks. For example, each of the plurality of basic blocks may be implemented to include a plurality of dense blocks and operation elements, as shown in FIG. 3B. In addition, each of the plurality of dense blocks may include a convolution layer, the activation function (e.g., ReLU function), or a spatial feature transform (SFT) layer, as shown in FIG. 4B. The SFT layer may generate an affine transform for spatial-unit feature modulation, and perform end-to-end learning using a loss function.

As an example, the first artificial intelligence model 300 may acquire the high-resolution image based on an optimal objective data combination for each of a plurality of regions included in the low-resolution image. In this case, the first artificial intelligence model 300 may be implemented to learn the plurality of objective data acquired based on an arbitrary weight condition map Tt acquired based on a condition t that is changed arbitrarily. The condition t may be a weight value corresponding to the plurality of SFT layers and may be changed continuously within a predetermined range.

FIG. 4C is a diagram illustrating an example learning method of the first artificial intelligence model 300, which is described in detail based on Equations provided below.

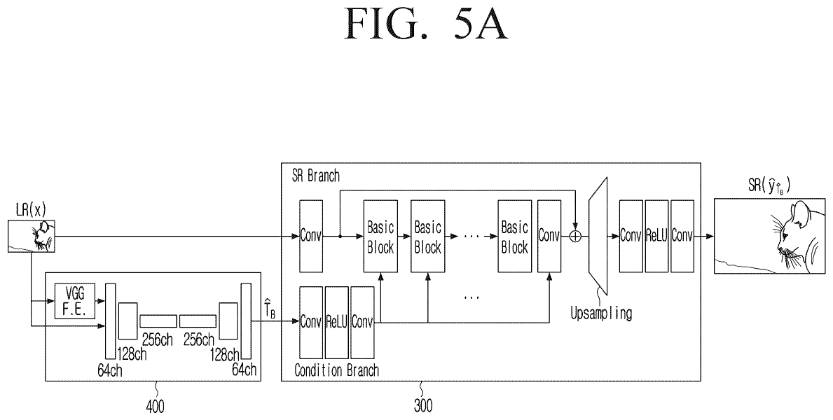

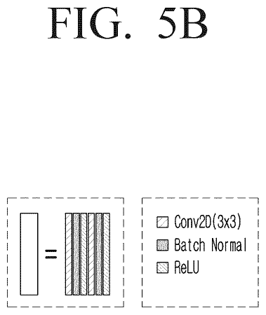

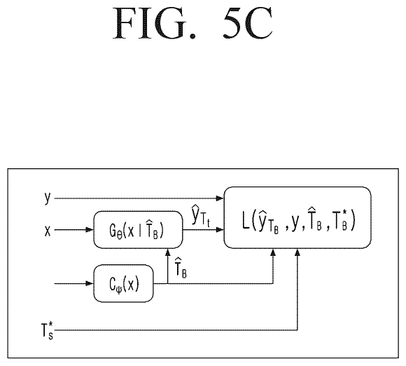

FIGS. 5A, 5B and 5C are diagrams illustrating an implementation example of the first artificial intelligence model and the second artificial intelligence model according to various embodiments.

As an example, the second artificial intelligence model 400 may provide the first artificial intelligence model 300 with the weight condition corresponding to the plurality of SFT layers included in the first artificial intelligence model 300. For example, the weight condition may be provided in a form of the weight condition map Tt. The weight condition map may have a size corresponding to that of the low-resolution image. For example, the second artificial intelligence model 400 may acquire the weight condition map for the plurality of loss values respectively corresponding to the plurality of regions included in the low-resolution image and provide the same to the first artificial intelligence model 300. In this case, the first artificial intelligence model 300 may acquire the high-resolution image based on the weighted sum of the plurality of loss values corresponding to the weight condition map provided from the second artificial intelligence model 400.

The second artificial intelligence model 400 may acquire a target weight condition map T_{S}* by selecting t having the lowest learned perceptual image patch similarity (LPIPS) for each pixel while changing the condition t from a first value to a second value stepwise, and may be trained based on a target weight condition map Tₛ. In addition, the second artificial intelligence model 400 may be trained based on the plurality of loss values for measuring a difference between the output image and target high-resolution image of the second artificial intelligence model 400. For example, the second artificial intelligence model 400 may be trained and optimized using three loss values (pixel-wise objective map loss, reconstruction loss, and perceptual loss).

As an example, the second artificial intelligence model 400 may include a plurality of individual sub-networks as shown in FIG. 5A. For example, the individual sub-network may include a feature extractor F.E. and a predictor. FIG. 5B may show an example of a structure of a plurality of blocks included in the predictor.

FIG. 5C is a diagram illustrating an example learning method of the second artificial intelligence model 400, which is described in greater detail based on Equations provided below.

Hereinafter, the description describes the operation methods and learning methods of the first artificial intelligence model 300 and the second artificial intelligence model 400 in greater detail with reference to Equations below.

For example, the first artificial intelligence model 300 may be implemented as an SR model that may consider a locally different objective. For example, the first artificial intelligence model 300 may be implemented to learn objective data, which is defined as the weighted sum of the plurality of loss values of different types and changed continuously. In this case, it is important to set the objective effectively for accurate SR processing. For example, in case of perception-oriented SR, the first artificial intelligence model 300 may learn the objective data as a weighted sum of a pixel-wise reconstruction loss L_{rec}, an adversarial loss Lady, and a perceptual loss Lₚₑᵣ.

$$L = {λ}_{rec} \cdot {L}_{rec} + {λ}_{adv} \cdot {L}_{adv} + {\sum }_{{{per}_{l}}^{}} {λ}_{{per}_{l}} \cdot {L}_{{per}_{l}} \qquad [ Equation 3 ]$$

$${{L}_{{per}_{l}} = E [ ‖ {ϕ}_{{per}_{l}} ( y ) - {ϕ}_{{per}_{l}} ( y ) ) ‖}_{1} ] \qquad [ Equation 4 ]$$

$${per}_{l} ∈ \{ V 12 , V 22 , V 34 , V 44 , V 54 \} \qquad [ Equation 5 ]$$

Here, λ_{rec}, λ_{adv}, and λₚₑᵣₗ are weighting parameters for the corresponding losses, and φₚₑᵣᵢ(⋅) may indicate a feature map of the input extracted from a layer peri of a visual geometry group (VGG) network. For example, the VGG network may be implemented as 19 layers, and is not limited thereto. For example, 5 layers may be represented by Equation 5. For example, a receptive field may increase as a depth of the VGG network increases, and a feature of a shallow layer such as V12 or V22 and that of a deep layer such as V34, V44, or V54 may correspond to relatively low and high levels, respectively.

For example, the first artificial intelligence model 300 may define an SR objective space to identify an effective objective set. For example, an SR objective may be a weighted sum of seven loss terms as in Equation 3. Therefore, the objective space may be extended by these basis loss terms, and an arbitrary objective may be represented as a seven-dimensional vector of weighted parameters as in Equation 6 below.

$$λ = [ {λ}_{rec} , {λ}_{adv} , {λ}_{per} ] \qquad [ Equation 6 ]$$

Here, λₚₑᵣ∈R⁵ may be a weight vector of the perceptual loss.

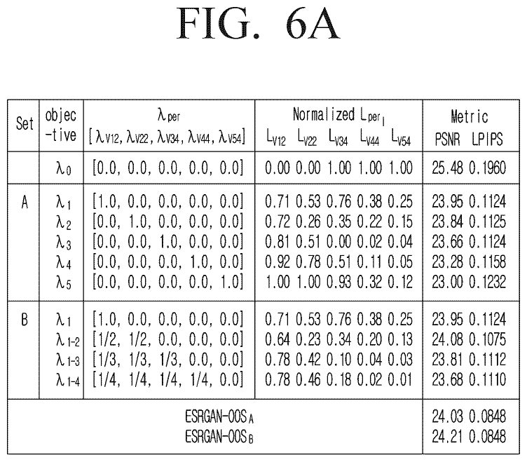

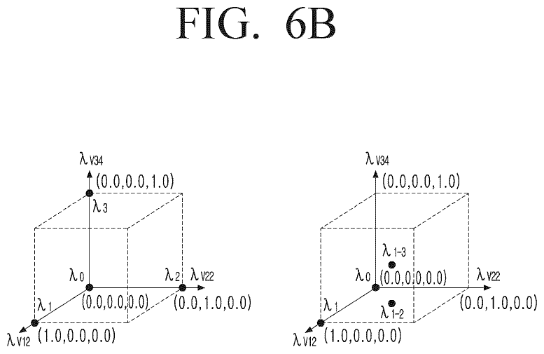

FIGS. 6A and 6B are diagrams illustrating an example objective set identification method according to various embodiments.

FIG. 6A is a table for comparing two objective sets A (left) and B (right) defined as in FIG. 6B. For example, an enhanced super-resolution generative adversarial network (ESRGAN) may be used as a base model, and λ_{rec} and λ_{adv} may be set to 1×10⁻² and 5×10⁻³, respectively, for all objectives in the table except λ₀. Values for the ESRGAN may be the same as each other except if λₚₑᵣ varies (∥λₚₑᵣ∥₁=1). For example, in a λₚₑᵣ term, each objective in set A may have the weight value for only one of five VGG feature spaces, while each objective in set B may have the same weight value for each loss in a feature space lower than a target vision level. A₀ may correspond to a distortion-oriented RRDB model, and λ_{rec} and λ_{adv} may be 1×10⁻² and 0, respectively. λ₀ may be included in both sets A and B.

As an example, the table in FIG. 6A may include a normalized version (e.g., min-max feature scaling) of the averaged λₚₑᵣᵢ from Equation 4 for five data sets (BSD100, General100, Urban100, Manga109, and DIV2K). For all the feature spaces including the targeted V12 and V22, λ₁₋₂ in set B may have smaller L1 error than λ₁ and λ₂ in set A. In addition, λ₁₋₄ may represent a smaller error than λ₄ or λ₅. In addition, λ₁₋₃ may have slightly more errors in the feature space including V34 than λ3. However, λ₁₋₃ may have a smaller error in the feature space including V12 or V22. Therefore, λ₁₋₃ may have relatively smaller distortion than λ₃, which is overfitted to the feature space including V34. This configuration may be supported by the fact that most of the objectives in set B, which includes λ₁₋₃, have a superior peak signal-to-noise ratio (PSNR) and learned perceptual image patch similarity (LPIPS) than those in set A.

The first artificial intelligence model 300 may mix six SR results of ESRGAN-λₐ (where, λₐ∈A) by selecting the SR result having the lowest LPIPS for each pixel position to examine the SR result that applies the locally appropriate objective using set A.

$${y}_{A}^{⋆} ( i , j ) = {y}_{{T}_{A}^{*} ( i , j )} ( i , j ) \qquad [ Equation 7 ]$$

$${T}_{A}^{*} ( i , j ) = arg {min}_{{λ}_{a} ∈ A} {LPIPS}_{λ a} ( i , j ) \qquad [ Equation 8 ]$$

$${LPIPS}_{λ a} = LPIPS ( y , {\hat{y}}_{λ a} ) \qquad [ Equation 9 ]$$

λₐ is the SR result of ESRGAN-a, and an LPIPS function may generate an LPIPS map having an input image size by calculating a perceptual distance between two image patches for each pixel position. An LPIPS metric in the table in FIG. 6A may be the average of these maps. T*_{A} is optimal objective selection (OOS), and T*_{A} and the SR model for mixing may be described as OOS_{A} and ESRGAN-OOS_{A}, respectively.

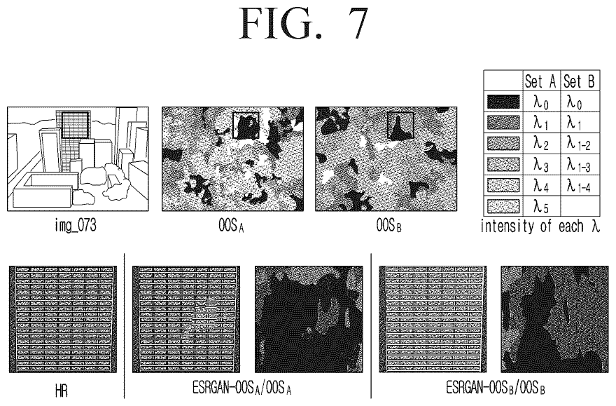

FIG. 7 is a diagram illustrating an example optimal objective selection method according to various embodiments.

An upper part of FIG. 7 shows examples of OOS_{A} and OOS_{B} based on set A and set B. The PSNR and LPIPS of ESRGAN-OOS_{A} and ESRGAN-OOS_{B} are the same as shown in the table in FIG. 3A, where ESRGAN-OOS_{B} may outperform any single objective model, and demonstrate potential for performance improvement in a locally appropriate objective application.

A lower part of FIG. 7 shows a side effect of mixing the SR result for set A, which has lower similarity between the objectives than set B, as shown in FIG. 6B. As shown in FIG. 7, ESRGAN-OOS_{B} may have a lower artifact and a superior PSNR than ESRGAN-OOS_{A}. Therefore, set B may be more appropriate for applying a locally appropriate object.

The first artificial intelligence model 300 may be trained on a set of objects for trajectories rather than a single object using Equation 6. An objective trajectory may be formed by connecting selected objectives, for example, five objectives from set B. The objects (e.g., objects from λ₀ to λ₁₋₄) may be connected from a low-vision-level object to a high-level object. λ(t)=<λ_{rec}(t); λ_{adv}(t); λₚₑᵣ(t)>may be defined using Equation below by a single variable t.

$$λ ( t ) = α \cdot {f}_{λ} ( t ) + β \qquad [ Equation 10 ]$$

$${f}_{λ} ( t ) = 〈 {f}_{{λ}_{rec}} ( t ) , {f}_{{λ}_{adv}} ( t ) , {f}_{{λ}_{per}} ( t ) 〉 \qquad [ Equation 11 ]$$

Here, f_{λper}(t), f_{λrec}(t), and f_{80 adv}(t) are weight value functions, and α and β are scaling and offset vectors. f_{λ}: R→R7, and this vector function may simplify a learning process by replacing a high-dimensional weight-vector manipulation with one-dimensional tracking.

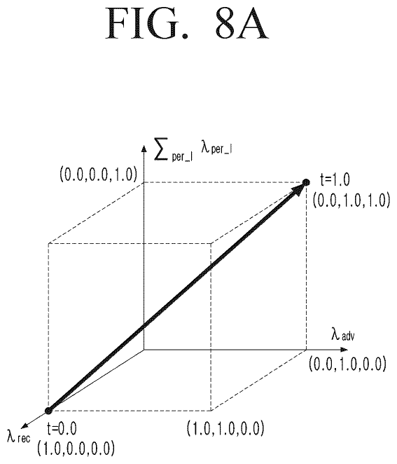

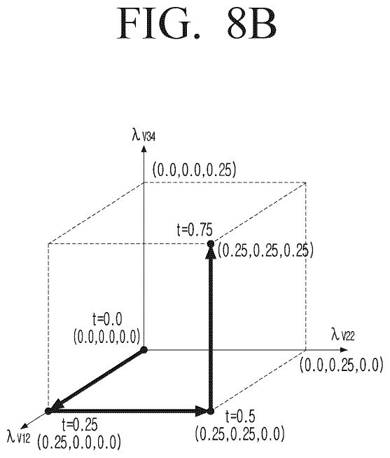

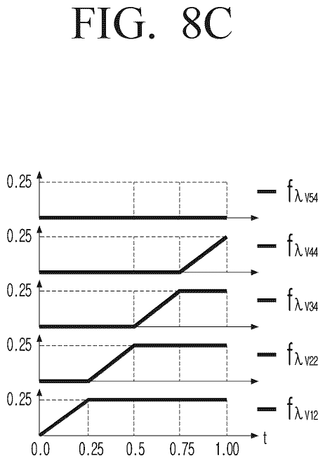

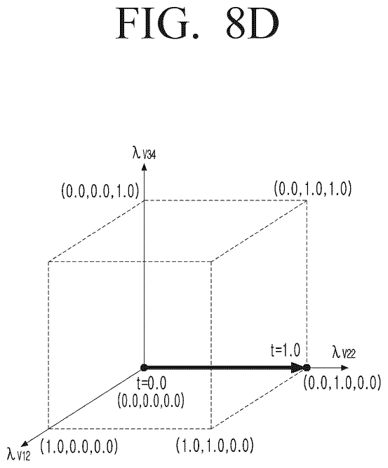

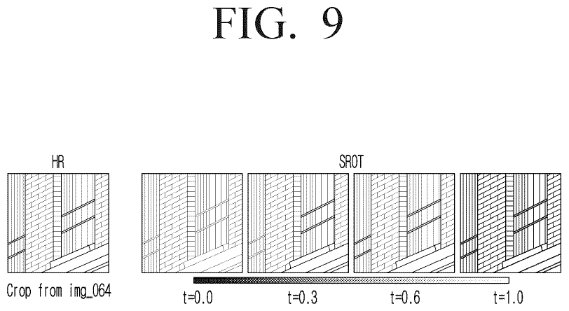

FIGS. 8A, 8B, 8C, 8D, and 9 are diagrams illustrating an example objective trajectory according to various embodiments.

For example, a trajectory design may be based on the table in FIG. 5A, which shows that the distortion-oriented RRDB model using λ₀ may have the smaller L1 error than all ESRGAN models for a low-level feature space such as V12 or V22, while the ESRGAN model may have smaller L1 errors for a high-level feature space such as V34, V44, or V54. Accordingly, as shown in FIG. 8A, the weight value functions f_{λper}, f_{λrec}, and f_{λadv} can be designed so that f_{λrec} increases and {f_{λadv}, Σₚₑᵣᵢf_{λperi}} decreases to λ₀ if t approaches 0, and conversely, {f_{λadv}, Σₚₑᵣᵢf_{λperi}} becomes λ₁₋₄ if t increases to 1.

Regarding a change of Σₚₑᵣᵢf_{λperi}, five component functions f_{λperi}(t) of f_{λper}(t) as shown in FIG. 8C may be designed to acquire the objective trajectory from λ₀ to λ₁₋₄ in set B as shown in FIG. 8B. However, the drawing shows only three of the five component functions due to a limitation of three-dimensional (3D) visualization. A weight value parameter for the objective may be changed by increasing the trajectory from 0 to 1, starting with the distortion-oriented objective λ₀, gradually adding higher vision-level feature space losses and the adversarial losses, and transitioning to the objective towards λ₁₋₄. FIG. 8D shows the objective trajectory used in flexible super-resolution (FxSR) that only uses the feature space including V22, which limits performance of perceptually accurate restoration.

The objective trajectory according to an embodiment may efficiently improve the accuracy and consistency of the SR result. It is possible to apply a more accurate objective to each region using an object on a continuous trajectory from a low-level vision to a high-level vision. In addition, based on the objective trajectory according to an embodiment, a high-level objective may include both a low-level loss and a high-level loss and thus provide a description of the lower-level objective. This weighting method may share structural components, which are mainly reconstructed by the low-level vision objective, among all the SR results on the trajectory. Finally, training a single SR model only once may reduce the number of models necessary to generate various HR outputs.

FIG. 9 is a diagram illustrating an example change in the SR result of a trained super-resolution objective trajectory (SROT) for the objective trajectory (OT) of FIG. 8B as t is changed from 0 to 1.

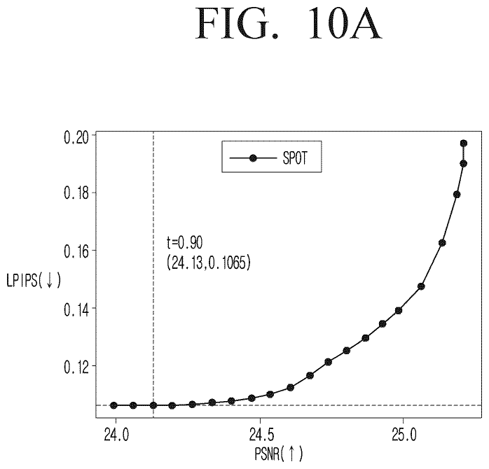

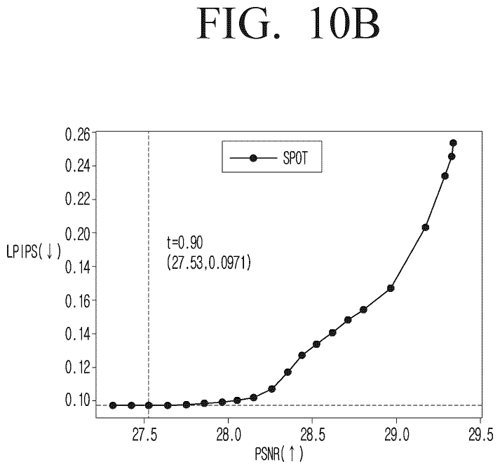

FIGS. 10A and 10B are graphs illustrating a trade-off curve in a perception-distortion plane based on the change in t according to various embodiments. t may increase from 0.0 to 1.0 in steps of 0.05, and may have 21 sample points. Each SR result on the curve may be acquired by inputting T, which has the same t throughout the image, as in Equation 12 below, into the condition branch of the first artificial intelligence model 300, such as Tₜ=1×t.

$${\hat{y}}_{{T}_{I}} = {G}_{θ} ( x \vert {\hat{T}}_{t} ) \qquad [ Equation 12 ]$$

Horizontal dotted lines and vertical dotted lines in FIG. 9 show a PSNR value corresponding to the lowest LPIPS value of each model, respectively. At each time point, a t value may be recorded next to a vertical line. However, applying the specific t to the entire image may still limit the SR performance, and an optimal t for each image is unable to be known at an inference time point. Accordingly, the description suggests a method for predicting and applying a locally optimal objective.

As an example, the first artificial intelligence model 300 may include two streams, e.g., the SR branch and the condition branch, each having 3 basic blocks.

For example, the condition branch may generate a shared intermediate condition that may be transmitted to all the SFT layers of the SR branch based on a target objective map T of the LR size. The SFT layer may modulate the feature map by applying the affine transform, and thus learn a mapping function for outputting a modulation parameter based on T. For example, Tₜ, where t is arbitrarily changed within a predefined range, may be provided as the condition branch. This modulation layer may allow the SR branch to optimize the objective that is modified by t. As a result, the first artificial intelligence model 300 may learn all the objectives on the trajectory and generate the SR result using a spatially different objective based on the map at the inference time point. For example, the first artificial intelligence model 300 may be optimized on a training sample Z=(x; y) using distribution P_{z} distribution (P_{z}) as shown in Equations 13 and 14 below.

$$θ *= arg {min}_{θ} {E}_{Z ∼ P z} [ L ( {\hat{y}}_{{T}_{t}} , y \vert t ) ] \qquad [ Equation 13 ]$$

$$L ( t ) = {λ}_{rec} ( t ) \cdot {L}_{rec} + {λ}_{adv} ( t ) \cdot {L}_{adv} + {\sum }_{{{per}_{l}}^{}} {λ}_{{per}_{l}} ( t ) \cdot {L}_{{per}_{l}} \qquad [ Equation 14 ]$$

The second artificial intelligence model 400 may be trained to predict an optimal objective combination for each region. The second artificial intelligence model 400 may generate the predicted optimal objective map for the LR image and provide the same to the first artificial intelligence model 300. It may be difficult for the second artificial intelligence model 400 to acquire the ground truth map for training the first artificial intelligence model 300. Therefore, the second artificial intelligence model 400 may acquire an approximation T*_{S} through simple exhaustive searching to narrow down a range of possible values as much as possible. For example, the second artificial intelligence model 400 may acquire N sets of SR results, for example, 21, by varying t from 0 to 1 in steps of 0.05, as shown in Equations 15 and 16 below, and select t having the lowest LPIPS for each pixel to thus generate the optimal objective map.

$${T}_{S}^{*} ( i , j ) = arg {min}_{t ∈ S} {LPIPS}_{t} ( i , j ) \qquad [ Equation 15 ]$$

$${LPIPS}_{t} = LPIPS ( y , {\hat{y}}_{{T}_{t}} ) \qquad [ Equation 16 ]$$

Here, Tₜ=1×t, t∈S {0.0. 0.05. 0.10. . . . 1.0}.

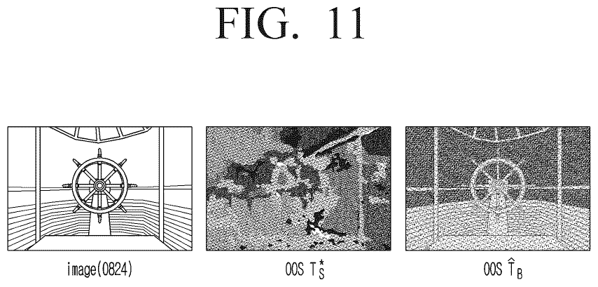

FIG. 11 is a diagram illustrating that the optimal objective selection (OOS) T*_{S} and α SR result SROOS using T*_{S} can be an upper bound approximation of the performance of the first artificial intelligence model 300 as shown in Equation 17 below according to various embodiments.

$${\hat{y}}_{{T}_{S}^{*}} = {G}_{θ} ( x \vert {T}_{S}^{*} ) \qquad [ Equation 17 ]$$

Although T*_{S} is useful for training the second artificial intelligence model 400, the pixel-wise objective selection without considering interference caused by the convolution of the first artificial intelligence model 300 may not be an accurate ground truth. Accordingly, the second artificial intelligence model 400 may be optimized by the loss value that measures a difference between a reconstructed image of the first artificial intelligence model 300 and the HR image. For example, the second artificial intelligence model 400 may be optimized using the three loss values (the pixel-wise objective map loss, the reconstruction loss, and the perceptual loss).

$$Ψ *= arg {min}_{Ψ} {E}_{{Z}_{T} \sim {P}_{{Z}_{T}}} L \qquad [ Equation 18 ]$$

$$L = {λ}_{T} \cdot {L}_{T} + {λ}_{rec}^{OOE} \cdot {L}_{rec} + {λ}_{R} \cdot {L}_{R} \qquad [ Equation 19 ]$$

$${L}_{R} = E [ LPIPS ( y , {\hat{y}}_{{\hat{T}}_{B}} ) ] \qquad [ Equation 20 ]$$

Here, L_{T} indicates an L1 loss between T*_{S} and T_{B}, and L_{rec} indicates the L1 loss between y and y_{TB}. Meanwhile, Z_{T}=(x, y, T*_{S}) indicates a training dataset, and λ_{T}, λ_{rec}^{OOE}, and λ_{R} indicate the weight values for the loss terms, respectively. While the second artificial intelligence model 400 is trained, the second artificial intelligence model 400 may be coupled with the trained first artificial intelligence model 300, and parameters 4 first artificial intelligence model 300 may be fixed. Accordingly, a loss in training the second artificial intelligence model 400 including the LPIPS may only be involved in predicting the optimal local objective map without affecting or changing the parameters of the first artificial intelligence model 300.

For example, the second artificial intelligence model 400 may include two individual sub-networks. One individual sub-network may be the feature extractor F.E. using VGG-19, and the other individual sub-network may be the predictor of a U-shaped convolutional neural network (UNet) architecture, as shown in FIG. 5A. For better performance, the feature extractor may acquire a high-level feature from a low-level feature and transmit the acquired feature to a UNet performing the prediction. A structure of the UNet may have a wider receptive region and thus be advantageous in predicting a context-specific objective.

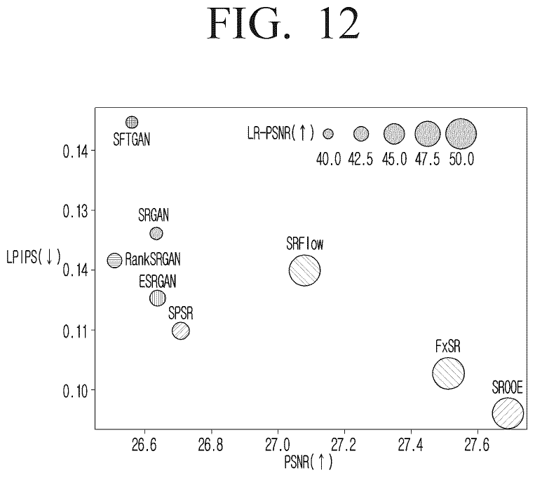

FIG. 12 is a diagram illustrating an example effect according to various embodiments.

Referring to FIG. 12, it may be seen that the super-resolution processing method (SROOE) according to an embodiment of the present disclosure provides superior results than other existing methods in LPIPS, DISTS, PSNR and SSIM metrics. For example, it may be seen that the super-resolution processing method (SROOE) according to an embodiment produces more accurate reconstructions of edge structures and details. For example, it may be seen that there is little change in the structural components between the SROOE results using T=0 and Tₛ, and sharp edges and generated details are added to the structural components of the region as needed.

According to the various embodiments described above, the super-resolution processing may enable the more accurate reconstruction and generation of edge structures and details.

The methods according to the various example embodiments of the present disclosure described above may be implemented by software upgrade or hardware upgrade of a conventional display device.

In addition, the various embodiments of the present disclosure described above may be performed by an embedded server disposed in the electronic device, or by a server disposed outside the electronic device.

According to the present disclosure, the various embodiments described above may be implemented by software including an instruction stored on a machine-readable storage medium (for example, a computer-readable storage medium). A machine may be a device that invokes the stored instruction from the storage medium, may be operated based on the invoked instruction, and may include the electronic device (e.g., electronic device 100) according to the disclosed embodiments. If the instruction is executed by the processor, the processor may directly perform a function corresponding to the instruction or another component may perform the function corresponding to the instruction under the control of the processor. The instruction may include codes generated or executed by a compiler or an interpreter. The machine-readable storage medium may be provided in the form of a non-transitory storage medium. Here, the “non-transitory” storage medium is tangible without including a signal, and does not distinguish whether data are semi-permanently or temporarily stored in the storage medium.

In addition, according to an embodiment of the present disclosure, the methods according to the various embodiments described above may be provided by being included in a computer program product. The computer program product may be traded as a commodity between a seller and α purchaser. The computer program product may be distributed in a form of the machine-readable storage medium (for example, a compact disc read only memory (CD-ROM)), or may be distributed online through an application store (for example, PlayStore™). In case of the online distribution, at least portions of the computer program product may be at least temporarily stored on the storage medium such as the memory of a manufacturer server, an application store server or a relay server, or be temporarily generated.

In addition, each of the components (e.g., modules or programs) according to the various embodiments described above may include a single entity or a plurality of entities, and some of the corresponding sub-components described above may be omitted or other sub-components may be further included in the various embodiments.

Alternatively or additionally, some of the components (e.g., modules or programs) may be integrated into the single entity, and may perform functions performed by the respective corresponding components before being integrated in the same or similar manner. Operations performed by the modules, the programs, or other components according to the various embodiments may be executed in a sequential manner, a parallel manner, an iterative manner or a heuristic manner, at least some of the operations may be performed in a different order or be omitted, or other operations may be added.

Although various embodiments are illustrated and described in the present disclosure as above, the present disclosure is not limited to the above-described embodiments, and may be variously modified by those skilled in the art to which the present disclosure pertains without departing from the gist of the present disclosure including the accompanying claims. These modifications should also be understood to fall within the scope and spirit of the present disclosure. It will also be understood that any of the embodiment(s) described herein may be used in conjunction with any other embodiment(s) described herein.

What is claimed is:

1. An electronic device comprising:
a display;
a memory storing information on a first artificial intelligence model and a second artificial intelligence model; and
at least one processor, comprising processing circuitry, connected to the display and the memory and individually and/or collectively configured to control the electronic device to: acquire a high-resolution image having a threshold resolution or higher from a low-resolution image below the threshold resolution using the first artificial intelligence model, and
control the display to output the acquired high-resolution image, wherein
the first artificial intelligence model is configured to learn objective data defined as a weighted sum of a plurality of loss values of different types and changed continuously, and
the second artificial intelligence model is configured to identify weight conditions corresponding to the plurality of loss values based on the low-resolution image and provide the identified weight conditions to the first artificial intelligence model.

2. The device as claimed in claim 1, wherein the second artificial intelligence model is configured to be trained based on:
first information including the output weight condition and target weight condition of the second artificial intelligence model, and
second information including the output image and objective data of the first artificial intelligence model.

3. The device as claimed in claim 2, wherein the first information includes a difference value between the output weight condition and target weight condition of each of the plurality of loss values of different types corresponding to region data of a training sample, and
the second information includes a plurality of loss values of different types between the region data of the training sample and the objective data that is changed continuously.

4. The device as claimed in claim 3, wherein the second information includes a pixel-wise objective map loss, a reconstruction loss, and a perceptual loss, representing a difference between the output image of the first artificial intelligence model and a target high-resolution image.

5. The device as claimed in claim 2, wherein the second artificial intelligence model is configured to predict a weight condition map of a size corresponding to the low-resolution image and provide the predicted map to the first artificial intelligence model, and
the first artificial intelligence model includes a super resolution (SR) branch including a plurality of spatial feature transform (SFT) layers and α condition branch providing conditions corresponding to the plurality of SFT layers based on the weight condition map.

6. The device as claimed in claim 1, wherein the first artificial intelligence model is configured to:
acquire the high-resolution image based on an optimal objective data combination for each of a plurality of regions included in the low-resolution image, and
learn the plurality of objective data acquired based on an arbitrary weight condition map acquired based on a condition t that is changed arbitrarily.

7. The device as claimed in claim 6, wherein at least one processor, individually and/or collectively, is configured to:
acquire the weight condition map for the plurality of loss values respectively corresponding to the plurality of regions included in the low-resolution image using the second artificial intelligence model, and
acquire the high-resolution image based on the weighted sum of the plurality of loss values corresponding to the acquired weight condition map using the first artificial intelligence model.

8. The device as claimed in claim 6, wherein at least one processor, individually and/or collectively, is configured to:
acquire a target weight condition map by selecting t having a lowest learned perceptual image patch similarity (LPIPS) for each pixel while changing the condition t from a first value to a second value stepwise using the second artificial intelligence model, and
train the second artificial intelligence model based on a difference value between the arbitrary weight condition map and the target weight condition map.

9. The device as claimed in claim 1, wherein the plurality of loss values of different types include a loss value based on at least one of a reconstruction loss, an adversarial loss, a perceptual loss, or a distortion loss.

10. A method of controlling an electronic device including a first artificial intelligence model and α second artificial intelligence model, the method comprising:
acquiring a high-resolution image having a threshold resolution or higher from a low-resolution image below the threshold resolution using the first artificial intelligence model; and
outputting the acquired high-resolution image,
wherein the first artificial intelligence model is configured to learn objective data defined as a weighted sum of a plurality of loss values of different types and changed continuously, and
the second artificial intelligence model is configured to identify weight conditions corresponding to the plurality of loss values based on the low-resolution image and provide the identified weight conditions to the first artificial intelligence model.

11. The method as claimed in claim 10, wherein the second artificial intelligence model is configured to be trained based on:
first information including the output weight condition and target weight condition of the second artificial intelligence model, and
second information including the output image and objective data of the first artificial intelligence model.

12. The method as claimed in claim 11, wherein the first information includes a difference value between the output weight condition and target weight condition of each of the plurality of loss values of different types corresponding to region data of a training sample, and
the second information includes a plurality of loss values of different types between the region data of the training sample and the objective data that is changed continuously.

13. The method as claimed in claim 12, wherein the second information includes a pixel-wise objective map loss, a reconstruction loss, and a perceptual loss, representing a difference between the output image of the first artificial intelligence model and a target high-resolution image.

14. The method as claimed in claim 11, wherein the second artificial intelligence model is configured to predict a weight condition map of a size corresponding to the low-resolution image and provide the predicted map to the first artificial intelligence model, and
the first artificial intelligence model includes a super resolution (SR) branch including a plurality of spatial feature transform (SFT) layers and a condition branch providing conditions corresponding to the plurality of SFT layers based on the weight condition map.

15. A non-transitory computer-readable medium storing a computer instruction which, when executed by at least one processor, comprising processing circuitry, of an electronic device, causes the electronic device to perform operations including:
acquiring a high-resolution image having a threshold resolution or higher from a low-resolution image below the threshold resolution using a first artificial intelligence model, and
outputting the acquired high-resolution image,
the first artificial intelligence model is configured to learn objective data defined as a weighted sum of a plurality of loss values of different types and changed continuously, and
a second artificial intelligence model is configured to identify weight conditions corresponding to the plurality of loss values based on the low-resolution image and provide the identified weight conditions to the first artificial intelligence model.

16. The non-transitory computer-readable medium of claim 15, wherein the second artificial intelligence model is configured to be trained based on:
first information including the output weight condition and target weight condition of the second artificial intelligence model, and
second information including the output image and objective data of the first artificial intelligence model.

17. The non-transitory computer-readable medium of claim 16, wherein the first information includes a difference value between the output weight condition and target weight condition of each of the plurality of loss values of different types corresponding to region data of a training sample, and
the second information includes a plurality of loss values of different types between the region data of the training sample and the objective data that is changed continuously.

18. The non-transitory computer-readable medium of claim 17, wherein the second information includes a pixel-wise objective map loss, a reconstruction loss, and α perceptual loss, representing a difference between the output image of the first artificial intelligence model and a target high-resolution image.

19. The non-transitory computer-readable medium of claim 16, wherein the second artificial intelligence model is configured to predict a weight condition map of a size corresponding to the low-resolution image and provide the predicted map to the first artificial intelligence model, and
the first artificial intelligence model includes a super resolution (SR) branch including a plurality of spatial feature transform (SFT) layers and a condition branch providing conditions corresponding to the plurality of SFT layers based on the weight condition map.

20. The non-transitory computer-readable medium of claim 15, wherein the acquiring the high-resolution image:
acquiring the high-resolution image based on an optimal objective data combination for each of a plurality of regions included in the low-resolution image, and
learning the plurality of objective data acquired based on an arbitrary weight condition map acquired based on a condition t that is changed arbitrarily.
